(19) United States
(12) Patent Application Publication
(10) Pub. No.: US 2005/0251301 A1
(43) Pub. Date: Nov. 10, 2005

(54) Throttle grip apparatus

(75) Inventor: Michiyuki Suzuki, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: ASAHI DENSO CO., LTD.

(21) Appl. No.: 11/111,796

(22) Filed: Apr. 22, 2005

(30) Foreign Application Priority Data
Apr. 23, 2004 (JP) P. 2004-128475

(51) Int. Cl. G05D 1/00

(52) U.S. Cl. 701/23

(57) ABSTRACT

A throttle grip apparatus is provided with a throttle grip rotatably mounted on a tip portion of a steering bar; an interlocking portion penetrated through the steering bar; a magnet formed at an edge portion of the interlocking portion; and an angle sensor that senses a change in magnetic fields of the magnet in a non-contact manner so as to detect a rotation angle of the throttle grip based upon the detected value of the magnetic field change. An engine may be controlled based upon the detected value of the angle sensor. The angle sensor has been penetrated through a mounting hole formed in a predetermined position of the steering bar, and arranged opposite to the magnet.

The present application claims foreign priority based on Japanese Patent Application No. P.2004-128475, filed on Apr. 23, 2004, the contents of which are incorporated herein by reference.

### THE INVENTION

1. Field of the Invention

The present invention is related to a throttle grip apparatus in which an engine of a vehicle is controlled in response to a rotation angle of a throttle grip.

2. Related Art

There is a motorcycle in which a rotation angle of a throttle grip is detected by throttle open degree sensor such as a potentiometer, the detected rotation angle is transferred as an electric signal to an electronic control apparatus, or the like, mounted on the motorcycle. Then, the electronic control apparatus executes a predetermined calculation based upon the detected rotation angle signal, and thus, controls ignition timing of an engine, or control opening/closing operations of an exhaust valve in the motorcycle.

Disclosed in JP-A-04-254278 is a throttle grip apparatus mainly constituted by a drive pulley unit, a detection-purpose gear, a potentiometer, and a case used to store thereinto these structural components. The drive pulley unit is rotated in an interlocking manner with a throttle grip. The detection-purpose gear is meshed with another gear which has been formed on a portion of this drive pulley unit. The potentiometer is used so as to detect a rotation angle of the detection-purpose gear. When a vehicle driver rotates the throttle grip, the potentiometer is rotated via the drive pulley unit, so that a throttle open degree may be detected.

However, in the throttle grip apparatus of JP-A-04-254278, the rotation angles of the throttle grip are detected via the drive pulley unit, the detection-purpose gear, and the like. As a result, there is a limitation as to the durability of the throttle grip apparatus of JP-A-04-254278. Also, since the meshing positions between the drive pulley unit and the detection-purpose gear are exclusively determined, there are other problems that the case must be made bulky and degrees of freedom as to designs of the case are lowered.

Therefore, one or more embodiments of the present invention has an object to provide such a throttle grip apparatus in which durability thereof can be improved by detecting a rotation angle of a throttle grip in a non-contact manner, and a case can be made compact, and further, a degree of freedom as to a design of the case can be improved.

### SUMMARY OF THE INVENTION

In accordance with one or more embodiments of the present invention, a throttle grip apparatus comprises a throttle grip rotatably mounted on a tip portion of a steering bar of a vehicle; an interlocking portion penetrated through the steering bar and rotated in conjunction with the throttle grip; a magnet provided at an edge portion of the interlocking portion; and an angle sensor arranged opposite to the magnet and penetrated through a mounting hole formed on the steering bar.

In accordance with one or more embodiments of the present invention, the angle sensor senses a change in magnetic fields of the magnet in a non-contact manner so as to detect a rotation angle of the throttle grip based upon the sensed value of the magnetic field.

In accordance with one or more embodiments of the present invention, an engine of the vehicle is controlled based upon the detected value of the angle sensor.

In accordance with one or more embodiments of the present invention, the mounting hole is formed in a switch case arranged in the vicinity of a base end of the throttle grip.

In accordance with one or more embodiments of the present invention, the switch case includes a switch used to operate various sorts of electronic equipments provided in the vehicle. In accordance with one or more embodiments of the present invention, the angle sensor is molded by employing a resin.

Other aspects and advantages of the invention will be apparent from the following description and the appended claims.

In accordance with one or more embodiments of the present invention, since the rotation angle of the throttle grip is detected by the angle sensor in the non-contact manner, durability of the throttle grip apparatus can be improved, and the case can be made compact, and further, degrees of freedom as to the design of the case can be improved.

In accordance with one or more embodiments of the present invention, since the mounting hole has been formed in the inner portion of the switch case on the steering bar, it is possible to avoid that rain water, foreign matters, and the like are entered into this mounting hole.

In accordance with one or more embodiments of the present invention, since the angle sensor has been molded by employing the resin, a water resistance effect as to this angle sensor can be improved. Furthermore, when the throttle grip apparatus is assembled, a penetration work of the angle sensor to the mounting hole may be carried out in an easy manner.

### BRIEF DESCRIPTION OF THE DRAWINGS

FIG. 1 is view for showing an outer apparatus of a throttle grip apparatus according to an embodiment of the invention.

FIG. 2A is a perspective view for representing an inner structure of a sensor component employed in the throttle grip apparatus of FIG. 1, as viewed from a front view.

FIG. 2B is a side view for showing the inner structure of the sensor component.

FIG. 3 is a longitudinal section view for indicating the throttle grip apparatus of FIG. 1.

### REFERENCE NUMERALS

1 throttle grip
1a interlocking unit
2 magnet
3 sensor component
3a angle sensor
4 steering bar
4a mounting hole
5 switch case

### DESCRIPTION OF THE PREFERRED EMBODIMENTS

Next, embodiments of the invention will be described with reference to the accompanying drawings.

A throttle grip apparatus according to the embodiment is used to detect a rotation angle of a throttle grip mounted on a steering bar of a vehicle (such as a motorcycle). A detection signal of the detected rotation angle is transmitted to an electronic control apparatus such as an ECU mounted on the vehicle. The throttle grip apparatus is mainly constituted by a throttle grip 1, an interlocking unit 1a, a magnet 2, and a sensor component 3.

While the throttle grip 1 has been mounted on a right-sided tip portion of a steering bar 4 of the vehicle, the throttle grip 1 is rotatable in a coaxial manner with respect to this steering bar 4. The throttle grip 1 constitutes a gripping portion 1b, the outer peripheral portion of which may be gripped by a vehicle driver. A rod-shaped interlocking portion 1a has been molded inside the throttle grip 1 in an integral manner. Also, in the throttle grip 1, a brim portion 1c is molded on the side of a base end thereof. The throttle grip 1 owns both a tube guide 1d and a sliding portion 1e, which have been molded in a substantially toroidal shape on the outer peripheral plane of this throttle grip 1.

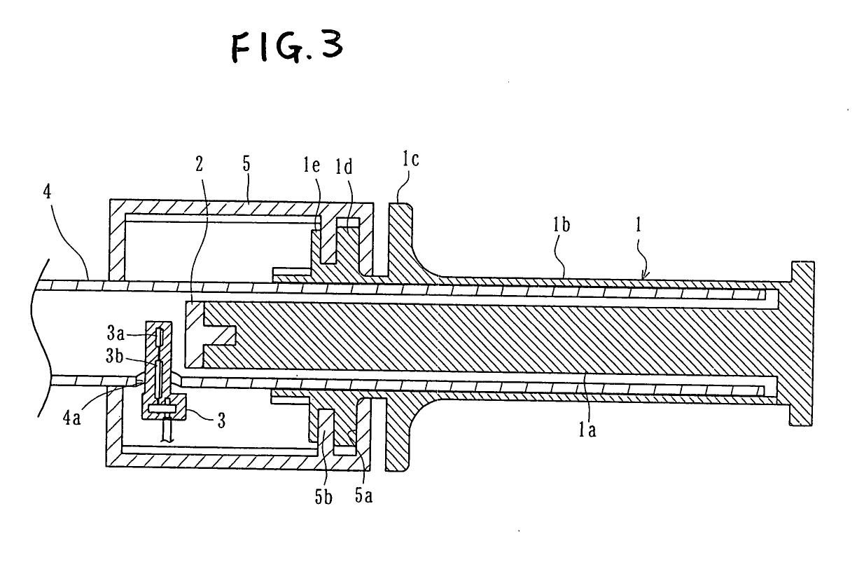

A switch case 5 has been arranged inside (namely, left side as viewed in FIG. 1 and FIG. 3) from the base end of the throttle grip 1 with respect to the steering bar 4. The switch case 5 contains a plurality of switches (not shown) which are employed so as to operate various sorts of electronic equipments provided in the vehicle. The base end of the throttle grip 1 has been covered by the switch case 5. Then, the tube guide 1d and the sliding portion 1e have been sandwiched in a slidable manner by an inner peripheral wall 5a and a convex-shaped portion 5d of the switch case 5 so that the throttle grip 1 has been supported.

The interlocking portion 1a corresponds to such a component which is penetrated through the pipe-shaped steering bar 4, and is rotated in conjunction with the throttle grip 1. The magnet 2 is fixed on an edge portion of this interlocking portion 1a. As a result, when the throttle grip 1 is rotated, the magnet 2 is also rotated in conjunction with the interlocking portion 1a, and a magnetic field may be changed. The magnetic field has been produced at a portion (namely, portion on the side of sensor component 3 shown in FIG. 3) which is located opposite to the magnet 2. It should be understood that the above-described magnet 2 may be realized as a permanent magnet, or other magnets (for example, plastic magnet etc.) capable of producing magnetic fields.

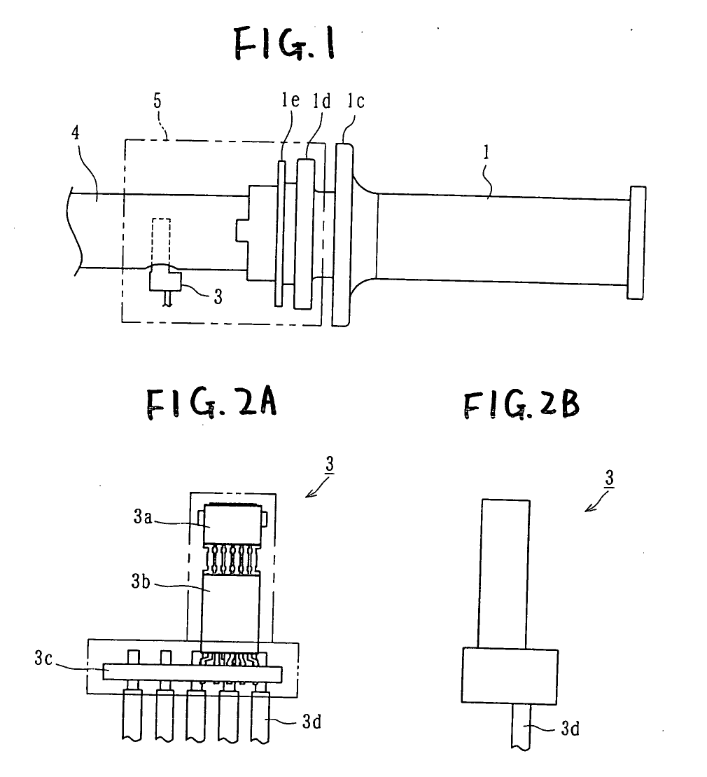

As indicated in FIGS. 2A and 2B, the sensor component 3 is manufactured by molding an angle sensor 3a, an amplifying unit 3b, and a board 3c in an integral manner by employing a resin. The angle sensor 3a increases and decrease an output voltage thereof in response to a change in magnetic fields generated from the magnet 2. The amplifying unit 3b amplifies the output signal (detection signal) derived from the angle sensor 3a. A cord 3d is provided and extended from the board 3c, while this cord 3d is employed so as to transfer the amplified detection signal to an external unit (not shown). The sensor component 3 has been penetrated through a mounting hole 4a formed in the steering bar 4 in such a manner that the angle sensor 3a is located opposite to the magnet 2.

In other words, when the magnet 2 formed on the edge portion of the interlocking portion 1a is rotated in conjunction with a rotation of the throttle grip 1, since the output signals of the angle sensor 3a are increased/decreased in response to the change in the magnetic fields produced from the magnet 2, the rotation angle of the throttle grip 1 may be detected based upon this sensor output signals. This sensor output signal is transferred via the cord 3d to the ECU provided by the two-wheeled vehicle, and thus, the engine is controlled based upon this transferred sensor output signal (namely, power control is carried out based upon rotation angle of throttle grip 1).

In this case, while the mounting hole 4a has been formed in the inner portion of the switch case 5 on the steering bar 4, the throttle grip apparatus of this embodiment mode has been arranged in such a manner that rain water, foreign matters, and the like are not entered from this mounting hole 4a into the switch case 5. As a result, a sealing member and the like are no longer required.

Next, a description is made of operations for assembling the throttle grip apparatus equipped with the above-described structure to the vehicle.

First, the board 3c where the angle sensor 3a, the amplifying unit 3b, and the cord 3d have been previously formed is molded by employing a desirable resin, and the sensor component 3 is prepared. Then, such a hole is made so as to form the mounting hole 4a by employing a drill, or the like at a portion of the steering bar 4, where the switch case 5 is arranged, which is located in the vicinity of a portion where the magnet 2 is positioned when the throttle grip 4 is mounted.

Thereafter, the sensor component 3 is penetrated through the mounting hole 4a in such a manner that the angle sensor 3a is positioned in the vicinity of a center position on a sectional plane of the steering bar 4. On the other hand, while the interlocking portion 1a is penetrated through the steering bar 4, the throttle grip 1 is mounted from the tip portion of the steering bar 4, and one pair of half-split shapes of the switch case 5 are fitted with each other to be tightened, so that this throttle grip 1 is supported in the rotatable manner. As a result, the magnet 2 formed on the edge portion of the interlocking portion 1a may be located opposite to the angle sensor 3a of the sensor component 3 which has been penetrated from the mounting hole 4a.

With execution of the above-described operations, the assembling work of the throttle grip apparatus according to this embodiment mode is accomplished. It should be understood that such an initial setting operation is carried out. That is, a detection is made of such an output voltage from the angle sensor 3a when the throttle grip 1 is located at an initial position, and then, this detected output voltage implies that the rotation angle in the throttle grip 1 is equal to a zero degree. In accordance with this throttle grip apparatus, since the rotation angle of the throttle grip 1 can be detected by the angle sensor 3a in the non-contact manner, durability of this throttle grip apparatus can be improved, as compared with that equipped with the mechanical angle sensing mechanism.

Also, since the angle sensor 3a is molded by employing the resin, the water resistance effect as to this angle sensor 3a can be improved. Furthermore, since the angle sensor 3a has been molded with other relevant structural elements (namely, amplifying unit 3b and board 3c) in the integral manner, the molded angle sensor 3a may be readily handled as the component, and also, when the throttle grip apparatus is assembled, the penetration work of the angle sensor 3a to the mounting hole 4a may be carried out in an easy manner.

While the throttle grip apparatus of this embodiment mode have been described in detail, the present invention is not limited thereto, but may be modified. For example, while the mounting hole 4a may be alternatively formed at another position of the steering bar 4, the sensor component 3 may be alternatively penetrated through this mounting hole 4a. As this position of the steering bar 4, a position which is exposed outside the switch case 5, or outside the steering bar 4 which is not equipped with the switch case 5 may be employed. In this alternative case, it is preferable that a sealing member may be arranged in order to embed such a gap which is formed between the mounting hole 4a and the sensor component 3. Also, although the throttle grip apparatus has been mounted on the steering bar 4 of the motorcycle in the embodiment, the throttle grip apparatus may be alternatively mounted on other vehicles (for instance, ATV (All Terrain Vehicle), snowmobile, boat, water vehicle, buggy etc.) having steering bars.

The throttle grip apparatus can be applied to a throttle grip apparatus having a different appearance, or a throttle grip apparatus additionally equipped with other functions, if only a magnet is provided which can be rotated in conjunction with a throttle grip of a vehicle, an angle sensor is penetrated through a mounting hole formed in a steering bar, and a rotation angle of this throttle grip may be detected in a non-contact manner.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

1. A throttle grip apparatus comprising:
a throttle grip rotatably mounted on a tip portion of a steering bar of a vehicle;
an interlocking portion penetrated through the steering bar and rotated in conjunction with the throttle grip;
a magnet provided at an edge portion of the interlocking portion; and
an angle sensor arranged opposite to the magnet and penetrated through a mounting hole on the steering bar.

2. The throttle grip apparatus according to claim 1, wherein the angle sensor senses a change in magnetic fields of the magnet in a non-contact manner so as to detect a rotation angle of the throttle grip based upon the sensed value of the magnetic field.

3. The throttle grip apparatus according to claim 1, wherein an engine of the vehicle is controlled based upon the detected value of the angle sensor.

4. The throttle grip apparatus according to claim 1, wherein the mounting hole is formed in a switch case arranged in the vicinity of a base end of the throttle grip.

5. The throttle grip apparatus according to claim 4, wherein the switch case includes a switch used to operate various sorts of electronic equipments provided in the vehicle.

6. The throttle grip apparatus according to claim 1, wherein the angle sensor is molded by a resin.

7. The throttle grip apparatus according to claim 4, wherein the angle sensor is molded by a resin.
